(19) United States
(12) Patent Application Publication
(10) Pub. No.: US 2014/0267000 A1
(43) Pub. Date: Sep. 18, 2014

(54) Systems and Methods for Automatically Entering Symbols into a String of Symbols Based on an Image of an Object

(71) Applicants: Jenny Yuen, Menlo Park, CA (US); Luke St. Clair, Menlo Park, CA (US)

(72) Inventors: Jenny Yuen, Menlo Park, CA (US); Luke St. Clair, Menlo Park, CA (US)

(21) Appl. No.: 13/797,337

(22) Filed: Mar. 12, 2013

(51) Int. Cl. G06F 3/00

(52) U.S. Cl. CPC G06F 3/005
USPC 345/156

(57) ABSTRACT

In one embodiment, a method includes, in connection with a user entering a string of symbols into a graphical user interface (GUI) of a mobile computing device, capturing an image of an object with a sensor on the mobile computing device, automatically identifying the object from the image, automatically determining one or more symbols associated with the object as identified from the image, and automatically entering the symbols into the string of symbols.

### TECHNICAL FIELD

This disclosure generally relates to systems and methods for providing input to a computer system, including providing input to a mobile computing and/or communication system using an input device having an electronic visual display, such as a touch screen, and automatically entering symbols into a string of symbols based on an image of an object.

### BACKGROUND

A mobile computing and communication device, such as a smartphone, tablet computer, or laptop computer, is widely used to perform a variety of computing and communication tasks. Computing and communication devices may include one or more input devices to receive a user input, such as a keyboard, pointing device, microphone, camera, or other suitable input device. Some computing devices can allow a user to provide input on an electronic visual display, such as a touch screen. In this manner, a user can provide input by touching a certain portion of the electronic visual display corresponding to a desired input. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter is related to a method including, in connection with a user entering a string of symbols into a graphical user interface of a mobile computing device, capturing an image of an object with a sensor on the mobile computing device, automatically identifying the object from the image, automatically determining one or more symbols associated with the object as identified from the image, and automatically entering the symbols into the string of symbols.

For example and as embodied herein, such a method may allow a user to capture an image of an object in connection with inputting a string of symbols into a graphical user interface and automatically identify and determine what the object is so that one or more symbols associated with the object are automatically entered into the string of symbols the user is inputting. As an example, a user may input a string of symbols, such as “I am at the,” and hold up the computing device to capture an image of a baseball field. In that example, the computing device may automatically identify the baseball field from the image and automatically determine one or more symbols that are associated with the baseball field, such as the textual symbols “baseball field” or a pictorial representation of a baseball field. The computing device may automatically enter the textual symbols “baseball field” into the string of symbols to form the phrase “I am at the baseball field.” Alternatively, the computing device may insert a pictorial representation of the baseball field in-line with the string of symbols. As such, the user saves time entering phrases and reduces the chances of misspelling an object.

In some embodiments, the image may be captured by scanning a Quick Response (QR) code or a bar code. For example, a user may hold the mobile computing device with the sensor facing a QR code or a bar code. In that example, the mobile computing device may automatically scan the QR code or bar code. In other embodiments, the mobile computing device may capture the image by photographing an object. For example, the mobile computing device may photograph an object when the user performs a user gesture, such as tapping an icon, swiping a predetermined portion of the touchscreen, or holding a button on the virtual keyboard for a predetermined period of time. As yet another example, the mobile computing device may automatically photograph the object. As such, the user may capture an image without separately activating the sensor so that the user may quickly finish entering the string of symbols into the graphical user interface.

In particular embodiments, the mobile computing device may automatically identify the object from the image at least in part by OCR. In other embodiments, the mobile computing device may identify the object from the image at least in part by bar code recognition. In some embodiments, the mobile computing device automatically identifies the object from the image locally. In other embodiments, the mobile computing device may send data associated with the image to a remote server and the remote server may identify the object. In that embodiment, the remote server may return data associated with the symbols associated with the object captured in the image. As such, the user may identify unknown objects for easy entry into the string of symbols.

In some embodiments, the one or more symbols associated with the object may include text. For example, if the object is a beer bottle, the symbols associated with the beer bottle may include text, such as the brand name of the beer. In that example, the user may type the message “I am drinking a” and mobile computing device may enter the brand name of the beer after capturing the image. In other embodiments, the one or more symbols associated with the object may include a pictorial representation of the object. For example, if the object is a basketball, the symbols associated with the basketball may include a pictorial representation of a basketball, such as an emoticon graphic associated with the basketball. As such, the user saves time entering phrases and reduces the chances of misspelling an object.

The disclosed subject matter is also related to one or more computer-readable non-transitory storage media embodying software that is operable when executed to: in connection with a user entering a string of symbols into a graphical user interface of a mobile computing device, capture an image of an object with a sensor on the mobile computing device, automatically identify the object from the image, automatically determine one or more symbols associated with the object as identified from the image, and automatically enter the symbols into the string of symbols.

The disclosed subject matter is further related to a system including one or more processors and a memory coupled to the processors. The memory includes instructions executable by the processors. The processors are operable when executing the instructions to: in connection with a user entering a string of symbols into a graphical user interface of a mobile computing device, capture an image of an object with a sensor on the mobile computing device, automatically identify the object from the image, automatically determine one or more symbols associated with the object as identified from the image, and automatically enter the symbols into the string of symbols.

### BRIEF DESCRIPTION OF THE DRAWINGS

FIG. 1 illustrates an example network environment associated with a social-networking system.

FIG. 2 illustrates an example social graph.

FIG. 3 illustrates an example scenario in which a client system automatically enters one or more symbols associated with an object captured in an image.

FIG. 4 illustrates an example method for automatically entering symbols into a string of symbols based on an image of an object.

FIG. 5 illustrates an example computer system.

### DESCRIPTION OF EXAMPLE EMBODIMENTS

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 164 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g. relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g. third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g. an enterprise, business, or third-party application), or a group (e.g. of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g. an image of the cover page of a book); a location (e.g. an address or a geographical location); a website (which may be associated with a URL); contact information (e.g. a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g. “eat”), causing a client system 130 to send to social-networking system 160 a message indicating the user's action. In response to the message, social-networking system 160 may create an edge (e.g. an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

FIG. 3 illustrates an example scenario in which a client system automatically enters one or more symbols associated with an object captured in an image. FIG. 3 shows an example personal computing device 300. In particular embodiments, personal computing device 300 includes touchscreen 310. Personal computing device 300 may include graphical user interface (“GUI”) 320. In particular embodiments, GUI 320 includes virtual keyboard 330 for inputting a string of symbols in field 350. For example, user 101 may use virtual keyboard 320 to enter the string “Meet me at” in field 350. As discussed below and in connection with entering the string of symbols in field 350, personal computing device 300 may enter one or more symbols related to an object captured in an image to complete that string of symbols. In an embodiment, GUI 320 may display message 340 from another user.

In some embodiments, personal computing device 300 may include sensor 360. Sensor 360 may be positioned on the front or back of personal computing device 300, or both. Sensor 360 may include any sensor capable of capturing an image of an object 370. For example, sensor 360 may be a still camera. As another example, sensor 360 may be a video camera. In some embodiments, user 101 may perform a user gesture on GUI 320 to capture an image. For example, user 101 may aim sensor 360 towards a building and tap icon 380 to capture an image of the building. As another example, user 101 may capture an image by swiping across a predetermined portion of touchscreen 310 or holding any key on virtual keyboard 330 for a predetermined period of time. In other embodiments, personal computing device 300 may capture an image automatically without a user gesture on touchscreen 310. For example, user 101 may aim sensor 360 towards the building and personal computing device 300 may automatically capture an image of the building. In some embodiments, personal computing device 300 includes a low-power image recognition chipset (not shown) so that sensor 360 may be on at all times. As such, user 101 may type a message and capture an image without having to separately activate sensor 360.

In an embodiment, personal computing device 300 may automatically identify object 370 from the image and may automatically determine one or more symbols associated with object 370 as identified from the image. For example, personal computing device 300 automatically identifies the building captured in the image and automatically determines one or more symbols associated with the building, such as textual symbols or a pictorial representation of the building. In other embodiments, personal computing device 300 may send first data associated with the image to a remote server, such as server 162 or a server located on third-party system 170. In that embodiment, personal computing device 300 may receive second data associated with the symbols associated with the object captured in the image from the remote server. In some embodiments, personal computing device 300 automatically enters the symbols into the string of symbols. Continuing the building example from above, personal computing device 300 may enter textual symbols representing the building's name into the string of symbols, such as “Meet me at Facebook Headquarters.” As another example, personal computing device may enter a pictorial representation of the building in-line with the string of symbols user 101 is entering.

Traditionally, user 101 may spend too much time entering a string of symbols to communicate to another user. For example, user 101 may enter “I am at the mall on Northside Drive.” That message may be time consuming to enter on a small virtual keyboard. Furthermore, user 101 may have difficulty identifying what a particular object is for inclusion in a text message or e-mail. For example, user 101 may input a text message discussing a particular building in a large city, but user 101 may not know the name of the building. In order to include the name of the building in the message, user 101 traditionally would be forced to perform an on-line search for the name of the building. This can be time consuming for user 101, particularly in large cities where user 101 may have difficulty finding the name of the building due to the volume of buildings.

According to one aspect of the disclosed subject matter, personal computing device 300, in connection with a user entering a string of symbols in GUI 320, may automatically identify an object captured in an image. Furthermore, in particular embodiments, personal computing device 300 may automatically determine one or more symbols associated with the object and automatically enter the symbols in-line into the string of symbols. For example, if user 101 is inputting the string “Meet me at” and user 101 captures an image of a building, personal computing device 300 may automatically identify the building and determine one or more symbols associated with the building, such as textual symbols representing the name of the building. In that example, personal computing device 300 may automatically enter the name of the building in-line with the string so that the string states “Meet me at Facebook Headquarters.”

FIG. 4 illustrates an example method 400 for automatically entering symbols into a string of symbols based on an image of an object. The method may begin at step 410, where personal computing device 300 receives a string of symbols in GUI 320. For example, user 101 may enter a string of symbols in a text message in GUI 320 of personal computing device 300. In particular embodiments, the string of symbols may include text. In other embodiments, the string of symbols may include a graphic, such as an emoticon. At step 420, personal computing device 300 captures an image of an object with sensor 360. In particular embodiments, personal computing device 300 may capture an image in response to user 101 holding personal computing device 300 with sensor 360 facing an object. In some embodiments, personal computing device 300 captures an image in response to receiving a user gesture. For example, user 101 may touch icon 380 to capture an image of the object. As another example, user 101 may swipe a predetermined portion of personal computing device 300 to capture an image. As yet another example, user 101 may hold a predetermined key on virtual keyboard 330 for a predetermined period of time. In other embodiments, personal computing device 300 automatically captures an image of the object without user 101 interacting with touchscreen 310. For example, user 101 may hold personal computing device 300 with sensor 360 facing an object and personal computing device 300 may automatically capture an image of the object after a predetermined period of time. In some embodiments, personal computing device 300 may capture an image by photographing an object. For example, user 101 may photograph a car. In other embodiments, personal computing device 300 may capture an image by scanning a QR code. For example, a coffee cup purchased from a coffee shop may include a QR code that user 101 may scan. In yet other embodiments, personal computing device 300 may capture an image by scanning a bar code. For example, a beer bottle may include a bar code that user 101 may scan. In an embodiment, personal computing device 300 may capture an image using a still camera. In other embodiments, personal computing device 300 may capture an image using a video camera.

At step 430, personal computing device 300 automatically identifies the object from the image. In an embodiment, the object is identified at least in part by OCR. For example, user 101 may be outside a particular building in a large city. User 101 may use personal computing device 300 to capture an image of an address engraved in the building's exterior. In that example, personal computing device may identify the object (e.g., the engraved address) using OCR and determine symbols, such as the address, associated with the object. The personal computing device 300 may enter the address into the string of symbols that user 101 was entering. As another example, user 101 may scan a bar code to identify an object, such as a beer bottle. In that example, personal computing device 300 may enter symbols associated with the beer bottle, such as its brand name, into the string of symbols the user was entering. In some embodiments, personal computing device 300 automatically identifies the object locally. For example, personal computing device 300 may utilize OCR or any image recognition software installed locally to perform the identification. As another example, personal computing device 300 may utilize a database of objects stored locally. In that example, the database may include an image of an object and its associated symbols, such as its name or a pictorial representation of the object. In other embodiments, personal computing device 300 communicates first data associated with the image to a remote server, such as server 162 or a server located on third-party system 170. In that embodiment, remote server 162 or the server located on third-party system 170 may identify the object in the same manner as the object is identified locally on personal computing device 300.

At step 440, personal computing device 300 automatically determines one or more symbols associated with the object as identified from the image. In some embodiments, personal computing device 330 automatically determines symbols associated with the object by looking up symbols associated with the object in a database stored locally or remotely. In other embodiments, personal computing device 330 automatically determines symbols associated with the object by automatically performing an Internet search for the object and returning a relevant text or pictorial representation of the object. In yet other embodiments, personal computing device 330 automatically determines symbols associated with the object using OCR software or other image recognition software, such as software capable of retrieving encoded symbols in a QR code or software capable of retrieving symbols from a database after scanning a UPC bar code. In particular embodiments, the symbols associated with the object may include text. For example, the image may include a photograph of a baseball and personal computing device 300 may automatically determine one or more symbols associated with the baseball, such as the textual symbols “baseball.” As another example, the image may be a scan of a bar code and the symbols associated with the bar code may include the brand name of the drink. In other embodiments, the symbols associated with the object may include a pictorial representation of the object. For example, the image may include a photograph of a car and personal computing device 300 may automatically determine one or more symbols associated with the car, such as an emoticon of a car. In particular embodiments, personal computing device 300 may automatically make the determination locally. In other embodiments, personal computing device 300 may send first data to a remote server as discussed above and receive from the server second data associated with the symbols associated with the object. Continuing the baseball example above, personal computing device 300 may receive second data associated with the symbols associated with the baseball, such as data associated with textual symbols “baseball” or data associated with an emoticon of a baseball.

At step 450, personal computing device 300 automatically enters the symbols into the string of symbols. In particular embodiments, the symbols are entered in-line with the string of symbols. For example, if user 101 is inputting a string of symbols, such as a text message, personal computing device 300 automatically enters one or more symbols associated with the object identified from the image in-line with the string of symbols. Continuing the baseball example from above, user 101 may enter a string of symbols, such as “Where is my” and personal computing device 300 may automatically enter the textual symbols “baseball” to form the phrase “Where is my baseball” or a pictorial representation of a baseball in-line with the phrase. As another example, user 101 may scan a bar code of a particular drink and personal computing device may enter textual symbols associated with the brand name of the drink into user's 101 phrase “I am drinking a ______.” As such, user 101 conserves time entering a phrase. At step 460, the method ends. Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a mobile computing device, in connection with a user entering a string of symbols into a graphical user interface (GUI) of the mobile computing device, capturing an image of an object with a sensor on the mobile computing device;
by the mobile computing device, automatically identifying the object from the image;
by the mobile computing device, automatically determining one or more symbols associated with the object as identified from the image; and
by the mobile computing device, automatically entering the symbols into the string of symbols.

2. The method of claim 1, wherein the sensor is a still or video camera.

3. The method of claim 1, wherein the image is captured in response to the user holding the mobile computing device with the sensor facing the object.

4. The method of claim 1, wherein:
the object is a Quick Response (QR) code; and
capturing the image of the object comprises scanning the QR code.

5. The method of claim 1, wherein capturing the image of the object comprises photographing the object.

6. The method of claim 1, wherein the object is identified at least in part by optical character recognition (OCR).

7. The method of claim 1, wherein the string of symbols comprises text.

8. The method of claim 1, wherein the symbols associated with the object comprise text.

9. The method of claim 1, wherein the symbols associated with the object comprise a pictorial representation of the object.

10. The method of claim 1, wherein automatically identifying the object from the image and automatically determining one or more symbols associated with the object as identified from the image comprises:
sending to a server computing device remote from the mobile computing device first data associated with the image; and
receiving from the server computing device second data associated with the symbols associated with the object.

11. One or more computer-readable non-transitory storage media embodying software that is operable when executed to:
in connection with a user entering a string of symbols into a graphical user interface (GUI) of a mobile computing device, capture an image of an object with a sensor on the mobile computing device;
automatically identify the object from the image;
automatically determine one or more symbols associated with the object as identified from the image; and
automatically enter the symbols into the string of symbols.

12. The media of claim 11, wherein the sensor is a still or video camera.

13. The media of claim 11, wherein the image is captured in response to the user holding the mobile computing device with the sensor facing the object.

14. The media of claim 11, wherein:
the object is a Quick Response (QR) code; and
the software is further operable when executed to capture the image of the object by scanning the QR code.

15. The media of claim 11, wherein the software is further operable when executed to capture the image of the object by photographing the object.

16. The media of claim 11, wherein the object is identified at least in part by optical character recognition (OCR).

17. The media of claim 11, wherein the string of symbols comprises text.

18. The media of claim 11, wherein the symbols associated with the object comprise text.

19. The media of claim 11, wherein the symbols associated with the object comprise a pictorial representation of the object.

20. The media of claim 11, wherein the software is further operable when executed to automatically identify the object from the image and automatically determine one or more symbols associated with the object as identified from the image by:
sending to a server computing device remote from the mobile computing device first data associated with the image; and
receiving from the server computing device second data associated with the symbols associated with the object.

21. A system comprising:
one or more processors; and
a memory coupled to the processors comprising instructions executable by the processors, the processors operable when executing the instructions to:
in connection with a user entering a string of symbols into a graphical user interface (GUI) of a mobile computing device, capture an image of an object with a sensor on the mobile computing device;
automatically identify the object from the image;
automatically determine one or more symbols associated with the object as identified from the image; and
automatically enter the symbols into the string of symbols.

22. The system of claim 21, wherein the sensor is a still or video camera.

23. The system of claim 21, wherein the image is captured in response to the user holding the mobile computing device with the sensor facing the object.

24. The system of claim 21, wherein:
the object is a Quick Response (QR) code; and
the processors further operable when executing the instructions to capture the image of the object by scanning the QR code.

25. The system of claim 21, wherein the processors are further operable when executing the instructions to capture the image of the object by photographing the object.

26. The system of claim 21, wherein the object is identified at least in part by optical character recognition (OCR).

27. The system of claim 21, wherein the string of symbols comprises text.

28. The system of claim 21, wherein the symbols associated with the object comprise text.

29. The system of claim 21, wherein the symbols associated with the object comprise a pictorial representation of the object.

30. The system of claim 21, wherein the processors are further operable when executing the instructions to automatically identify the object from the image and automatically determine one or more symbols associated with the object as identified from the image by:
sending to a server computing device remote from the mobile computing device first data associated with the image; and
receiving from the server computing device second data associated with the symbols associated with the object.
